(19) United States
(12) Patent Application Publication
(10) Pub. No.: US 2025/0019939 A1
(43) Pub. Date: Jan. 16, 2025

(54) TENSION MONITOR FOR UNDERCARRIAGE TRACK IN A WORK MACHINE

(71) Applicant: Caterpillar Inc., Peoria, IL (US)

(72) Inventors: Eric James Johannsen, Washington, IL (US); Li Zhang, Dunlap, IL (US)

(73) Assignee: Caterpillar Inc., Peoria, IL (US)

(21) Appl. No.: 18/221,542

(22) Filed: Jul. 13, 2023

(51) Int. Cl. E02F 9/26; B62D 55/125; B62D 55/21; G01P 1/07; G01P 15/18

(52) U.S. Cl. CPC E02F 9/267; B62D 55/125; B62D 55/21; G01P 1/07; G01P 15/18; G01P 1/023

(57) ABSTRACT

A work machine, such as a tractor or skid steer, has a motion sensor attached to a segment of a continuous ground-engaging track in its undercarriage. The motion sensor generates motion data indicative of a change in motion for the track segment as the track rotates around a track assembly. An electronic controller for the work machine receives and evaluates the motion data, first to identify a location of the track segment within the undercarriage and then to compare the motion data with expected motion data for the track segment under normal track tension. Motion data outside a range of the expected motion data indicates an abnormal sag in the track, causing the electronic controller to generate an alert for adjustment of the track tension.

### TECHNICAL FIELD

The present disclosure relates to a monitor of tension in an undercarriage track of a work machine. More specifically, the present disclosure relates to a monitoring system that detects tension variations within a ground track of a work machine using an electronic motion sensor positioned within the track.

BACKGROUND

Work machines, such as tractors, skid steers, dozers, and excavators, often have a continuous ground-engaging track on the left and right sides of the machine within an undercarriage. These tracks help provide traction to propel the machine and are typically formed as interconnected links pinned together into a looped chain. Depending on the implementation, track shoes within the track may have grousers to help enhance the ground traction. A drive sprocket on the machine has teeth that engage with the chain and cause the track to rotate around one or more idler wheels and track rollers for forward or reverse movement of the machine.

For effective operation of the machine, the track needs to maintain an appropriate tension around the drive sprocket and idlers. Excessive slack in the track, which can arise from wear in components engaging the track over time, may cause the track to slip off the drive sprocket or idler wheels. Replacement of the track causes expensive and disruptive downtime for the machine. Conversely, insufficient slack in the track may cause stress and wear on the engaging components, leading to premature degradation of the machine. Accordingly, the track tension needs to be monitored over time and adjusted if necessary.

One approach for monitoring track tension in a work machine is described in U.S. Pat. No. 7,172,257 (“the '257 patent”). The '257 patent describes a track tension adjusting device that includes a tension adjusting cylinder actuated by a hydraulic pump. A hydraulic sensor detects the hydraulic pressure in the tension adjusting cylinder, which is coupled to the track. A deviation from a specified pressure range indicates a change in track tension, which is then adjusted using the hydraulic pump to move an idler. Among other things, by inferring track tension from hydraulic pressure in an affiliated pump, the '257 patent provides an imprecise approach to determining track tension that may delay accurate recognition of tensioning problems.

Examples of the present disclosure are directed to overcoming deficiencies of such systems.

### SUMMARY

In an aspect of the present disclosure, a system for monitoring tension in an endless track of a machine includes a drive sprocket having teeth around a circular periphery, an idler having an outer circumference, and an endless track engaged with the teeth and with the outer circumference for movement at least over a span between the drive sprocket and the idler. A motion sensor is attached to a segment of the endless track and is configured to generate track data indicative of a change in motion by the motion sensor over the span. The system further includes a memory configured to store target data representative of an expected change in motion by the motion sensor over the span and a controller configured to determine that the track data is not within a range of the target data. An actuator is configured to generate an alert when the track data is not within the range of the target data.

In another aspect of the present disclosure, a work machine includes an engine configured to provide propulsion for the work machine and an undercarriage coupled to the engine for engaging a ground surface to move the work machine. The undercarriage includes a drive sprocket, an idler, and a ground-engaging track engaged with the drive sprocket and the idler for movement at least over a span between the drive sprocket and the idler. In addition, the undercarriage has a motion sensor, attached to a segment of the ground-engaging track. The motion sensor is configured to generate tension data indicative of a change in motion by the motion sensor over the span. The work machine further includes a memory configured to store target data representative of an expected change in motion by the motion sensor over the span and an electronic controller, communicatively coupled to the motion sensor. The electronic controller is configured to receive the tension data and indicate an alert when the tension data is not within a range of the target data.

In yet another aspect of the present disclosure, a computer-implemented method monitors tension in a track within an undercarriage of a work machine. The method includes receiving, by a processor, motion data from a motion sensor within a track segment during rotation of the track about a track assembly in the undercarriage. The processor then compares a portion of the motion data indicative of when the track segment was at a predetermined location offset from a drive sprocket with target motion data for the predetermined location stored in a memory. The method includes determining that the portion of the motion data is not compliant with the target motion data and generating an alert relating to tension for the track.

### BRIEF DESCRIPTION OF DRAWINGS

FIG. 1 is a diagrammatic side view of an exemplary track-type machine in accordance with an example of the present disclosure.

FIG. 2 is a partial schematic view of an undercarriage of the track-type machine in FIG. 1 having a tension detector in accordance with an example of the present disclosure.

FIG. 3 is an exploded isometric view of an exemplary portion of a track assembly of the track-type machine of FIG. 1 in accordance with an example of the present disclosure.

FIG. 4 is a partial side view of an exemplary track link of FIG. 2 within a tension monitoring system in accordance with an example of the present disclosure.

FIG. 5 is a flowchart depicting a method of monitoring track tension on the track-type machine of FIG. 1 in accordance with an example of the present disclosure.

### DETAILED DESCRIPTION

Consistent with the principles of the present disclosure, a work machine having undercarriage with a ground-engaging track includes a tension detector attached to a segment of the track. The tension detector includes a motion sensor configured to generate data indicative of changes in motion for the segment as the continuous track rotates around a track assembly in the undercarriage. An electronic controller, either within the tension detector or elsewhere, may evaluate the motion data to determine a location of the track segment at a point in time and to compare the change in motion for the track segment with historical data stored in memory. If the motion data for the track segment deviates from historical data for a properly tensioned track, the electronic controller may alert the operator of the work machine that an adjustment of the track is needed. The following describes several examples for carrying out the principles of this disclosure. Wherever possible, the same reference numbers will be used throughout the drawings to refer to same or like parts.

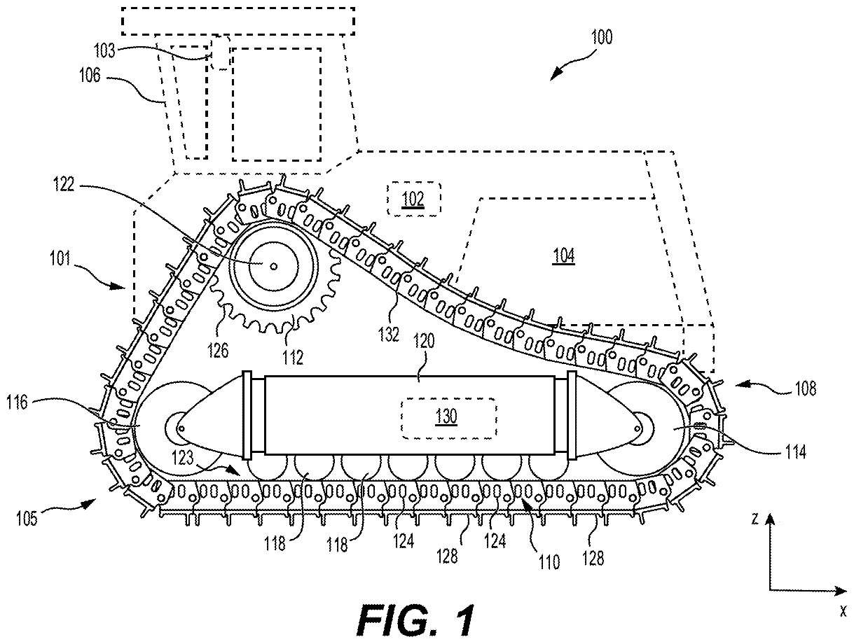

FIG. 1 illustrates an exemplary track-type machine 100 consistent with examples of the present disclosure. Track-type machine 100 may embody any machine that is driven, propelled, positioned, and/or maneuvered by operating a “continuous” or endless track-type traction device. Such machines may include, for example, track-type tractors, skid steers, dozers, excavators, backhoes, track loaders, front shovels, rope shovels, or any other type of track-maneuverable machine. Accordingly, machine 100 typically includes a work tool (not shown) for assisting in executing a function. For instance, machine 100 may cause movement of an affiliated tool depending on the need, such as a loader, bucket, pallet fork, broom, grinder, tiller, rake, blade, or auger, among others.

Machine 100 generally includes an upper body 101 supported by an undercarriage 105. Upper body 101 includes a cabin 106 configured for housing an operator of machine 100. As discussed further below, cabin 106 may include a workstation with various human-machine interfaces, such as controls, instruments, and indicators, useful for operating machine 100 and for receiving feedback on its behavior. An electronic control module (ECM) 102 and a communicator 103, each of which is discussed in more detail below, may reside within upper body 101 and receive, process, and send electronic information relating to the performance and configuration of machine 100, some of which may be useful for the operator within cabin 106.

Upper body 101 further includes an engine 104. Otherwise termed a power source, the engine produces and delivers mechanical power for operating various functions of machine 100, such as the power necessary to propel machine 100 and to operate various actuators and systems of machine 100. Typically, engine 104 is an internal combustion engine such as, for example, a diesel engine, a gasoline engine, an electric-gas hybrid engine, or any other configuration of engine known to one skilled in the art. Alternatively or additionally, driving mechanism 122 may embody an electric motor, electrically coupled to an electric power source and configured to convert at least a portion of the electrical energy into mechanical energy. According to yet another example, engine 104 may include a hydraulic motor fluidly coupled to a hydraulic pump and configured to convert a fluid pressurized by the pump into a torque output. Other features of the engine may include a fuel system, an exhaust system, and a cooling system, which are excluded from illustration and discussion solely for purposes of simplicity.

In the example of FIG. 1, engine 104 within upper body 101 propels machine 100 by causing movement of at least a track assembly 108 within undercarriage 105. As a right-side view, FIG. 1 shows only a single track assembly 108. At least a second track assembly corresponding to track assembly 108 would typically be positioned on the left side of machine 100 as well. In general, track assembly 108 includes a track 110, a drive sprocket 112, a front idler 114, a rear idler 116, multiple track rollers 118, and a frame assembly 120. These components of track assembly 108 are exemplary only and not intended to be limiting. Accordingly, track assembly 108 may include additional and/or different components than those listed above.

Engine 104 of machine 100 transmits power to drive sprocket 112 via a driving mechanism 122. Driving mechanism 122 may include a mechanical drive, a hydraulic drive, an electric drive, or a combination thereof. Drive sprocket 112 may be coupled to driving mechanism 122 via a shaft (not shown), which may provide an interface for delivering torque generated by engine 104 and driving mechanism 122 to rotate drive sprocket 112. For example, drive sprocket 112 may be secured (e.g., welded, bolted, heat-coupled, etc.) to a hub associated with a shaft (not shown), so that drive sprocket 112 rotates in response to the torque generated by driving mechanism 122. In some examples, drive sprocket 112 may be directly coupled via a drive shaft to driving mechanism 122. Alternatively, drive sprocket 112 may be coupled to the driving mechanism via a torque converter (such as a gearbox, transmission, etc.), so that rotation of drive sprocket 112 is proportional to the torque generated by driving mechanism 122.

Track 110 forms a continuous or endless loop structure as a ground-engaging portion of machine 100. Track 110 is operatively coupled to drive sprocket 112, front idler 114, rear idler 116, and track rollers 118. In general, rotation of drive sprocket 112 causes track 110 to move around a periphery or circumference of drive sprocket 112, first idler 114, track rollers 118 and rear idler 116 to engage the ground and thereby propel machine 100 in a manner known in the art. In general, clockwise rotation of drive sprocket 112 and track 110 in FIG. 1 will cause a forward movement of machine 100 (left to right in FIG. 1 along the X axis), while counterclockwise rotation of drive sprocket 112 and track in FIG. 1 will cause a reverse movement of machine 100 (right to left in FIG. 1 along the-X axis).

In one example, track 110 includes a chain 123 formed from a plurality of interconnected track links 124. It should be understood that “track link,” as used herein, refers to any linkage component of a continuous chain for a track-type machine. In one example, adjacent (e.g., consecutive) track links 124 may be coupled together via a plurality of track pin assemblies described further below. The track links 124 are engaged by teeth 126 of drive sprocket 112 to drive chain 123 of track 110 around drive sprocket 112, front idler 114, rear idler 116, and track rollers 118. In the example of FIG. 1, track 110 will have a length generally determined by the path of traversal around drive sprocket 112, front idler 114, track rollers 118, and rear idler 116 for machine 100.

Track 110 within track assembly 108 may include a plurality of track shoes 128. Each track shoe 128 may include a connecting portion configured to be secured to one or more track links 124 and a ground-engaging portion configured to contact the ground. The ground-engaging portion may include one or more features (e.g., grouser bars) that provide increased traction between track shoes 128 and the ground. It should be understood, however, that any type of track shoe forming a part of a track assembly used by a track-type mobile machine may be implemented consistently with the present disclosure. In some examples, track shoes 128 may be integrally formed with track links 124. In other embodiments, track shoes 128 may be omitted entirely from track assembly 108, so that surfaces of track links 124 that would otherwise contact track shoes 128 may contact the ground surface under machine 100.

As known to those of ordinary skill in the field, track 110 has a tension when mounted within machine 100 that may change over time. For example, the radii of front idler 114 and rear idler 116 may decrease due to metal-on-metal contact with track links 124 or due to contact with abrasive debris in the environment. As these components wear, the circumferential trajectory of track 110 around front idler 114 and rear idler 116 decreases. Similarly, the radial thickness or height of track links 124 may decrease due to the same interaction, and cause a corresponding increase in the internal circumferential length of track 110. These changes can lead to a decreased tension for track 110, resulting in a sagging of track 110 at locations between drive sprocket 112 and front idler 114 (when traveling in a forward direction) and between drive sprocket 112 and rear idler 116 (when traveling in a reverse direction).

Frame assembly 120 provides a housing for components affiliated with the retention and operation of front idler 114, rear idler 116, and track rollers 118. In addition, in some examples, frame assembly 120 includes a track tension actuator 130. Track tension actuator 130 within frame assembly 120 is configured to enable adjustment of the sagging and tension of track 110 by displacing front idler 114 away from or towards rear idler 116. That is, by adjusting displacement using track tension actuator 130, tension of track 110 may be modified by increasing or decreasing the circumferential trajectory of chain 123 around drive sprocket 112, front idler 114, and rear idler 116 to substantially match the internal circumferential length of chain 123.

In some examples, track tension actuator 130 is a grease cylinder that, when manually filled with grease, extends to push front idler 114 away from rear idler 116 (i.e., along the X axis in FIG. 1). Conversely, when grease is removed, track tension actuator 130 as a grease cylinder when tend to allow front idler 114 to be moved toward rear idler 116 (i.e., along the-X axis in FIG. 1). Alternatively, actuator 28 could be a fluid cylinder having one or more chambers automatically filled with fluid pressurized by an onboard source, the pressurized fluid acting on a piston/rod combination to move front idler 114. It is contemplated that other manual, automatic, linear, and/or rotary configurations of track tension actuator 130 may also or alternatively be employed, as desired.

While the tension of track 110 may decrease over time as wear occurs, adjustment using track tension actuator 130 may also result in the tension of track 110 being too high. Sag between drive sprocket 112 and front idler 114 may be eliminated, leading to a taut chain 123. In this situation, track 110 may impart stresses on its supporting components, such as drive sprocket 112, causing undesirable wear and degradation. Accordingly, track tension actuator 130 would need to be adjusted again to shift the relative positions of front idler 114 and rear idler 116 to achieve an acceptable tension for track 110 based on the operation on machine 100.

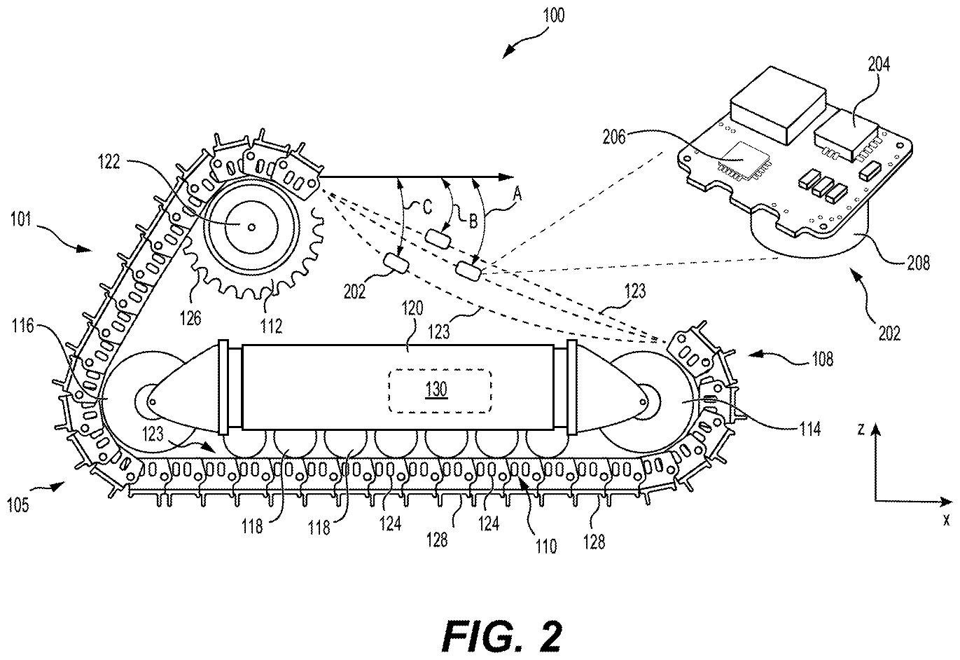

In accordance with the principles of the present disclosure, to assist with detecting and adjusting tension for track 110, at least one portion of track 110 may be configured as a sensing segment 132. In some examples as illustrated in FIG. 1, sensing segment 132 includes a track link or a track shoe positioned between drive sprocket 112 and front idler 114 as machine 100 is moving forward (i.e., traversing in the direction of the X axis). Sensing segment 132 includes, in some examples, one or more electronic devices capable of and configured to detect its motion, from which a spatial position for sensing segment 132 can be derived, in a manner discussed further below with respect to FIGS. 2-4.

FIG. 2 is partial schematic view of undercarriage 105 depicted in FIG. 1 for machine 100. For purposes of discussion, a portion of track 110 extending between drive sprocket 112 and front idler 114 has been removed and replaced with a generalized depiction of chain 123 having different amounts of tension under three scenarios. In a first scenario labeled as “A” in FIG. 2, chain 123 has an intended amount of tension for the operating conditions and for machine 100, indicated as a slight amount of sag between drive sprocket 112 and front idler 114. In a second scenario, labeled as “B” in FIG. 2, chain 123 has little slack or sag between drive sprocket 112 and idler 114 indicating a high amount of tension for track 110. In a third scenario, labeled as “C” in FIG. 2, chain 123 has excessive slack or sag indicating a low amount of tension.

As generally depicted in FIG. 2, a tension detector 202 may be positioned within sensing segment 132 (see FIG. 1) of chain 123. Tension detector 202 is an electronic circuit containing one or more components capable of and configured to sense a change in motion of the device. Typically, tension detector 202 includes at least one motion sensor 204 to determine and process various modes of motion, such as acceleration, vibration, shock, tilt, or rotation. In one example, motion sensor 204 is a MEMS (microelectromechanical system) component, which often uses differential capacitors to detect one or more modes of motion. As illustrated in FIG. 2, tension detector 202 may be constructed as a circuit board containing motion sensor 204 and affiliated electronics, including a communication device 206 for interfacing with processing equipment such as ECM 102 and a battery 208 for providing power for the electronics on tension detector 202.

In some examples, motion sensor 204 within tension detector 202 is a MEMS gyroscope configured to detect the angular rate of motion, i.e., rotation, of the sensor. As chain 123 exits drive sprocket 112 when machine 100 moves in a forward direction (i.e., along the X axis), sensing segment 132 will undergo an angular rate of motion as it moves downwardly (i.e., along the -Z axis in FIGS. 1 and 2) toward front idler 114. The degree or rate of that angular motion will vary based on the amount of sag in chain 123, i.e., based on the tension of track 110. For instance, in scenario A of FIG. 2, chain 123 has what may be termed an optimal or desired amount of tension with a slight amount of sag between drive sprocket 112 and front idler 114. As tension detector 202 moves away from drive sprocket 112, the angular rate of motion for motion sensor 204 will change according to an expected amount. In contrast, for scenario B in which chain 123 is tight and little sag exists between drive sprocket 112 and front idler 114, the angular rate of motion for motion sensor 204 will be comparatively less than for the optimal scenario A. Similarly, for scenario C in which chain 123 is loose and a high amount of sag or slack exists between drive sprocket 112 and front idler 114, the angular rate of motion for motion sensor 204 will be comparatively larger than for the optimal scenario B. Accordingly, motion sensor 204 within tension detector 202 provides an indication of the relative sag within chain 123, which may be used to determine whether track 110 is at a preferred tension for maintaining engagement and minimizing wear within track assembly 108 or whether an adjustment is needed using track tension actuator 130.

Other types of detection may be used by motion sensor 204 to provide an indication of relative slack in chain 123. For example, motion sensor 204 may be an accelerometer, which detects linear motion as a change in velocity in a unit of time, or a vibration sensor. A three-axis MEMS accelerometer, for instance, can sense the rotation or inclination of its position in space, and therefore also of tension detector 202, providing evidence of the path of travel for sensing segment 132 after it leaves drive sprocket 112, whether for scenario A, scenario B, scenario C, or some other scenario of tension.

In addition to providing motion data indicative of sag in chain 123, motion sensor 204 may be used by machine 100 to determine a location of sensing segment 132 within undercarriage 105. As alluded to above, an evaluation of sag or slack in chain 123 is most representative of tension in track 110 when sensing segment 132 is between drive sprocket 112 and first idler 114 while machine 100 is moving in a forward direction. In some examples, data from motion sensor 204 can be used to identify when the sensor is in that position. For example, with a gyroscope as motion sensor 204, data of an angular rate of motion from motion sensor 204 can be compared with previously captured data of the angular rate of motion for the device during its traversal around undercarriage 105. Data indicating moderate and repetitive angular changes, for example, may indicate the passage of motion sensor 204 over track rollers 118. Data indicating sharp changes in angular motion may indicate, for instance, that motion sensor 204 is passing around one of the wheels, namely, drive sprocket 112, front idler 114, or rear idler 116. Motion data may be collected and stored for the passage of sensing segment 132 in its circular path within undercarriage 105 and used as a template or standard against which new motion data may be compared to identify the location of sensing segment 132 within undercarriage 105 at any point in time and, particularly, when motion sensor 204 has passed beyond drive sprocket 112 and is moving toward front idler 114.

In some examples, tension detector 202 stores data in a memory (not shown) relating to a target sag profile for chain 123 in the span between drive sprocket 112 and front idler 114 against which new data from motion sensor 204 may be compared. The target sag profile may correspond to a preferred amount of sag in chain 123 in this span for avoiding track slippage and undue wear on equipment within track assembly 108. Although scenario A in FIG. 2 provides one example of potential target sag profile, the target sag profile may vary based on the characteristics, size, age, and use for machine 100. Tension detector 202 may evaluate incoming motion data from motion sensor 204 based on the location determination for sensing segment 132 and compare the incoming motion data for the appropriate location of motion sensor 204 with the predetermined and stored target sag data to conclude whether track 110 is in or out of compliance with respect to tension.

In order to perform this data processing, tension detector 202 may include circuitry components configured to generate, receive, transmit, and/or modify signals and data indicative of motion detected by motion sensor 204 as discussed above. For example, while FIG. 2 illustrates motion sensor 204, other circuitry components not shown may include a signal conditioner, an amplifier, a multiplexer, and/or a converter (e.g., an analog-to-digital (A/D) converter or a digital-to-analog (D/A) converter). A controller (not shown), such as a low-power microcontroller, may process input received from motion sensor 204 and/or a memory device (not shown). Memory device may be either or both of a random-access memory (RAM) and a read-only memory (ROM) and may store information related to one or more of the input received from motion sensor 204, such as data relating to the location of sensing segment 132 in its route around undercarriage 105, a target sag profile, or incoming motion data, for example. Alternatively or additionally, a memory device may store instructions used by one or more other components of tension detector 202 or the controller.

As indicated in FIG. 2, tension detector 202 includes a power source in the form of battery 208, in one example. In other examples, the power source may additionally or alternatively include a motion-based energy source, such as a vibration-based energy-harvesting system, to power one or more of the components of tension detector 202, and/or may be used to charge battery 208. In yet another example, battery 208 may be capable of being wirelessly charged (e.g., near-field charging). In this way, tension detector 202 may be embedded within sensing segment 132 while being capable of receiving electrical power from outside of track 110, and thus reducing on-board battery requirements. It should be understood that these components are exemplary and that additional and/or alternative circuitry components may be used, depending on the configuration of tension detector 202.

Although FIG. 2 shows examples of specific components used by tension detector 202, tension detector 202 is not limited to the configuration shown. Rather, consistent with the disclosure, tension detector 202 may include other components, more components, or fewer components than those described above. Further, it is contemplated that one or more of the hardware components listed above may be implemented in part or wholly using software. One or more of such software components may be stored on a tangible, non-transitory computer-readable storage medium that includes computer-executable instructions that, when executed by a processor or other computer hardware, perform methods and processes consistent with the disclosure.

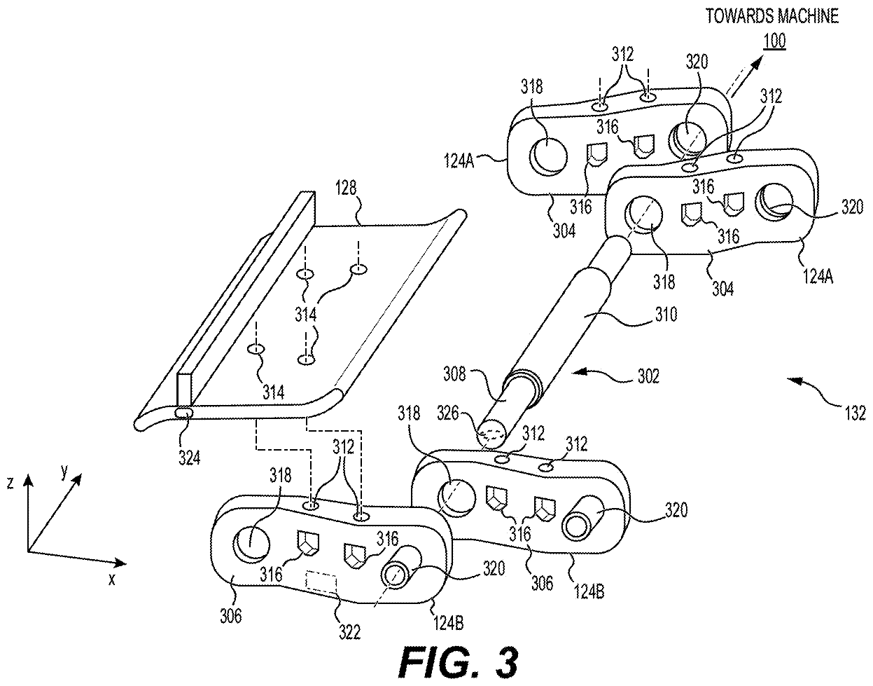

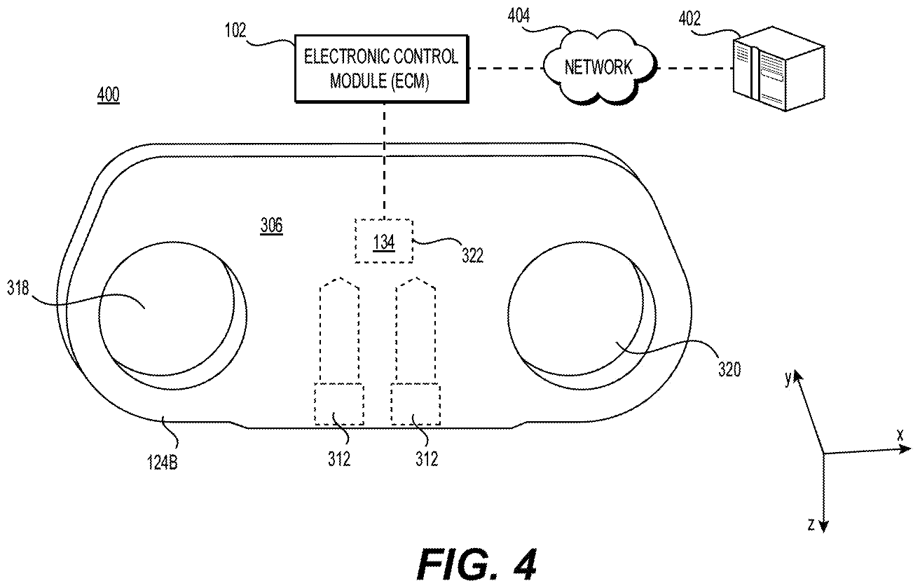

While FIG. 2 schematically illustrates the mounting of motion sensor 204 on a circuit board of tension detector 202, at least one tension detector 202 may in turn be mounted in or on sensing segment 132. In some examples, tension detector 202 is secured to an exterior surface of sensing segment 132. In other examples, tension detector 202 is at least partially embedded in the body of sensing segment 132, as further explained below with respect to FIGS. 3 and 4.

FIG. 3 is an exploded view of a representative sensing segment 132 that forms a portion of track 110. Sensing segment 132 of FIG. 3 includes four track links 124, one track pin assembly 302, and one track shoe 128. As shown in FIG. 3, track links 124 may include track links 124A and track links 124B, which may be mirror images of each other disposed on opposite sides of track assembly 108. Accordingly, track links 124A form one side of track assembly 108 (e.g., side of track assembly nearer to a center of machine 100 and farther along the Y axis in FIG. 3), while track links 124B form the opposite side of track assembly 108 (e.g., a side of track assembly farther from the center of machine 100).

The components shown in FIG. 3 may be assembled with one another to form sensing segment 132. Specifically, one track pin assembly 302 may be used to connect four track links 124 (e.g., two track links 124A and two track links 124B). One track shoe 128 may be connected to one track link 124A and one track link 124B. Another track shoe 128 (not shown) may be connected to the other track link 124A and the other track link 124B.

Each track link 124 includes an inward-facing surface 304 and an outward-facing surface 306. Inward-facing surfaces 304 may face toward a center of chain 123 (e.g., toward the opposite-side track link). Conversely, outward-facing surfaces 306 may face away from the center of chain 123. As shown in FIG. 2, track links 124A may be connected to each other such that an inward-facing surface 304 is connected to an outward-facing surface 306 of an adjacent track link 124A. Likewise, track links 124B may be connected to each other such that an inward-facing surface 304 is connected to an outward-facing surface 306 of an adjacent track link 124B. It should be understood, however, that other track link configurations are possible.

As shown in FIG. 2, each track pin assembly 302 that connects track links 124 may include a track pin 308 and a bushing 310. Bushing 310 may be disposed on track pin 308, such that bushing 310 rotates relative to track pin 308. By this arrangement, teeth 126 of drive sprocket 112 (FIG. 1) may engage bushing 310. As a result of force applied to bushing 310 from teeth 126, track pin 308 may be translated along the X axis, resulting in movement of track 110 and corresponding movement of machine 100 on the ground surface in a manner known in the field.

Each track link 124A and 124B may include one or more through holes 312, while each track shoe 128 may include corresponding through holes 314. Each track link 124A and 124B may also include one or more openings 316 aligned with a through hole 312. By this arrangement, threaded fasteners such as bolts (not shown) may be disposed within through holes 312 and 314 to attach track shoes 128 to track links 124A and 124B, and corresponding threaded fasteners such as nuts (not shown) may be disposed on the ends of the bolts. Openings 316 may be formed to facilitate placement or tightening of the nuts on the ends of the bolts, such as by being sized, shaped, or located to accommodate a tool that may be used to tighten the nuts.

Each of track links 124A and 124B may define a plurality of additional through holes 318, 320 configured to receive at least a portion of track pin assemblies 302 in a manner known in the art. For example, through holes 318 may be configured to receive a portion of bushing 310 and through holes 320 may be configured to receive a portion of a free end of track pin 308. In this way, pivot joints may be formed at track pin assemblies 302, allowing chain 123 to move freely around drive sprocket 112, front idlers 114, rear idler 116, and track rollers 118 during operation.

Tension detector 202 may be mounted on or within any structure of sensing segment 132 in accordance with the needs of the implementation. In some examples, tension detector 202 is adhered to a surface of chain 123, such as on inward-facing surface 304 or outward-facing surface 306 of a track link 124A or 124B. The track link 124A, 124B selected to include tension detector 202 may depend on a number of factors, such as track link position within track assembly 108 and orientation with respect to machine 100, and the means by which tension detector 202 is mounted to the selected track link 124. For example, if either of track links 124A includes tension detector 202, tension detector 202 would be positioned closer to machine 100 than if either of track links 124B includes tension detector 202. Similarly, if tension detector 202 is mounted to or adjacent an inward-facing surface 304 or outward-facing surface 306, the orientation of the selected track link 124 will determine whether tension detector 202 faces toward machine 100 or away from machine 100. These factors may be considered when determining the position of a track link 124 that includes tension detector 202 based on the implementation for machine 100.

Due to the rugged environment in which machine 100 may operate, tension detector 202 may advantageously be embedded within a cavity in chain 123 to protect it from damage. As depicted in FIG. 3, in one possibility, outward-facing surface 306 of track link 124B includes a cavity 322 sized to accept and retain tension detector 202. Cavity 322 may alternatively be placed in inward-facing surface 304 or in track link 124A as the implementation warrants. Wherever located, cavity 322 may be machined into the track link or manufactured by casting, forging, or the like. In an alternative illustrated in FIG. 3, track shoe 128 within sensing segment 132 may include a cavity 324 for retaining tension detector 202. Being in contact with the ground, track shoe 128 is subject to the rigors of traction as track 110 rotates. Nonetheless, an embedded location along a side of track shoe 128 may provide an acceptable option for mounting tension detector 202 in some implementations, as may other locations within track shoe 128. In yet another option, track pin 308 within sensing segment 132 may include a cavity 326 for retaining tension detector 202. While shown in FIG. 3 at the axial end of track pin 308, cavity 326 could be positioned in a radial side of track pin 308 or any convenient location suitable for the implementation. Any other structure within sensing segment 132 could also suffice for retaining tension detector 202.

Tension detector 202 may be situated within cavity 322 and retained in a permanent or in a removable configuration. In one possibility, a containment mechanism (not shown) such as a potting epoxy may be introduced into cavity 322 to protect and hold tension detector 202 in place after curing to form a solid material. The containment mechanism may be chosen to provide sufficient strength and physical protection to tension detector 202 while enabling electrical communications to occur using communication device 206. In another option, tension detector 202 may be retained within a housing configured to be removably or permanently installed within cavity 322, 324, or 326, such as with the use of threads, a detent mechanism, clips, etc. In some examples, the containment mechanism may include a cover (not shown) configured to seal an opening into cavity 322, 324, or 326. For example, tension detector 202 may be held in place by fasteners (e.g., threaded fasteners) and a cover may close tension detector 202 within cavity 322, 324, or 326 to protect tension detector 202 from damage. While different cavities and containment mechanisms are depicted and described, it should be understood that there may be other means for mounting tension detector 202 on or within track link 124, track shoe 128, or track pin 308.

In some examples, the components within tension detector 202 are kept to a minimum to conserve space, electrical power, and processing capability within track 110. Accordingly, tension detector 202 may primarily contain motion sensor 204, communication device 206, and battery 208, along with ancillary electronic components. In this arrangement, tension detector 202 communicates data received from motion sensor 204 to processing equipment located outside of track 110. In this configuration, processing capabilities for motion data from motion sensor 204 may reside outside tension detector 202 within machine 100.

FIG. 4 is a schematic diagram illustrating tension detector 202 in communication with other electrical and processing components elsewhere in machine 100 to form part of a tension monitoring system 400 for the machine. In FIG. 4, track link 124B is isolated from sensing segment 132 for illustration with tension detector 202 shown installed within cavity 322. In this example, tension detector 202 is mounted within cavity 322 in outward-facing surface 306 of track link 124B and is communicatively coupled with ECM 102 on machine 100. As discussed above and shown in FIG. 2, tension detector 202 includes a communication device 206 capable of and configured to receive and transmit signals to and from tension detector 202. In addition to communication device 206, tension detector 202 may include one or more components for communicating information signals, such as an antenna, transceiver, or transmitter. These functional elements may be incorporated within communication device 206, motion sensor 204, or other integrated circuits within tension detector 202. In most situations, communication from tension detector 202 would occur wirelessly using industry protocols, such as Bluetooth communication standards.

ECM 102 typically contains an antenna configured to receive signals from other devices, along with a processor and memory suitable for receiving and evaluating data generated by motion sensor 204. In some examples, ECM 102 has the capability of communicating wirelessly with tension detector 202 using Bluetooth or similar protocols. Accordingly, motion data generated by motion sensor 204 can be intermittently or continuously received by ECM 102. After receiving this motion data, ECM 102 can process the data, along with other machine data accessible to ECM 102, to determine positional parameters for sensing segment 136, such as its location along track 110 within undercarriage 105, its angular rate of change if motion sensor 204 is a gyroscope, its position in space if motion sensor 204 is an accelerometer, its frequency of vibration if motion sensor 204 is a vibration sensor, or other possible data. Alternatively, an on-board computer may reside within a dashboard of cabin 106 and be suitable for communicating wirelessly with communication device 206 within tension detector 202. Other options for processing data generated by motion sensor 204 may also exist within machine 100, as will be appreciated by those of ordinary skill in the field.

As also shown in FIG. 4, ECM 102 may additionally or alternatively share at least motion data generated by motion sensor 204 with a computing system 402 situated remotely from machine 100. ECM 102 may communicate directly with off-board computing systems such as computing system 402, or machine 100 may route communications through communicator 103, which may accomplish longer range connections. Computing system 402 can be one or more servers, computers, or other off-board computing devices. For example, while machine 100 is located at a worksite, computing system 402 can be located at a back office or other location that is remote from machine 100, or that is remote from the worksite overall. As illustrated in FIG. 4, computing system 402 can communicate wirelessly with at least machine 100 via a network 404.

Whether processing of motion data occurs within tension detector 202, ECM 102, computing system 402, or elsewhere, the processing may determine whether tension for track 110 is in or out of compliance with an acceptable value. As will be apparent to those of ordinary skill in the field, the received motion data may be compared with stored data relating to a target sag profile to determine if the sag of chain 123 beyond drive sprocket 112 while machine 100 is in forward motion is within acceptable values. For example, the processing may at least in part determine a vertical position for sensing segment 132 (i.e., along the Z axis in FIGS. 1 and 2) relative to a top of drive sprocket 112 when sensing segment 132 is at a predetermined distance horizontally (i.e., along the X axis in FIGS. 1 and 2) from the top of drive sprocket 112. In some examples, the vertical position is compared with stored values for acceptable vertical positions at that corresponding horizontal position, which may correspond to a target sag profile. If the vertical position is outside an acceptable tolerance range from the acceptable vertical positions, the processing equipment may conclude that tension for track 110 needs to be adjusted. It will be apparent that “acceptable” positions or behavior for motion sensor 204 will depend on the characteristics of machine 100 and its implementation.

Following a conclusion that track 110 needs to have its tension adjusted, machine 100 in some examples provides an alert to the operator. In some examples, the alert may be a warning provided visually on a dashboard of cabin 106, an audible sound broadcast within cabin 106, or some other mechanism for conveying the conclusion to the operator. The alert may indicate that adjustment of tension is needed and, alternatively, whether the tension is too high or too low. Following the alert, the operator may then adjust the tension of track 110 using track tension actuator 130 in a conventional manner. Alternatively, machine 100 may include equipment for automatically adjusting hydraulic pressure within track tension actuator 130 based on the motion data provided from motion sensor 204.

Turning from the architecture of machine 100 and options for monitoring tension in an undercarriage track as illustrated in FIGS. 1-4, FIG. 5 is a flowchart of a representative method 500 for monitoring tension in a track using a motion sensor positioned within the track. This process 500 is illustrated as a logical flow graph, operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the process.

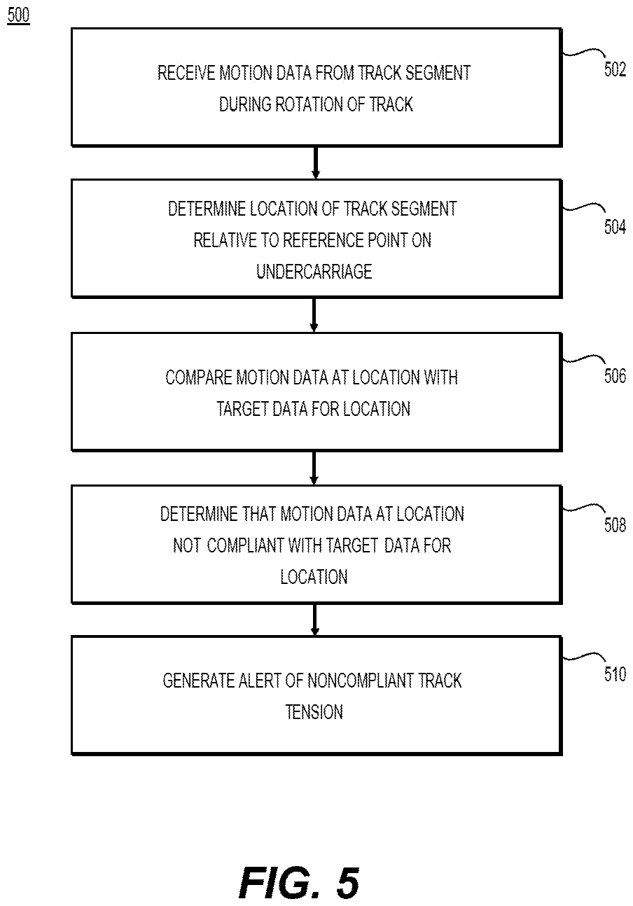

In FIG. 5, the example method 500, at step 502, includes processing equipment, or other electronic controllers or processors on a machine, receiving motion data from a track segment during rotation of the track about a track assembly in an undercarriage. As shown in FIGS. 1-4, a computer processor or controller as embodied, for example, in ECM 102 can collect motion data from motion sensor 204 embedded or otherwise attached to sensing segment 132 as track 110 rotates. Motion sensor 204 could be a MEMS gyroscope or MEMS accelerometer, for example, within a circuit board of tension detector 202. The tension detector 202 has the capability to transmit signals to ECM 102 that include motion data generated by motion sensor 204. Alternatively, the processor or controller could be implemented within tension detector 202 itself.

In a second step of 504, the processing equipment determines a location of the track segment relative to a reference point on the undercarriage. In some examples, a reference point on the undercarriage 105 of machine 100 could be the vertical top of drive sprocket 112 (i.e., along the Z axis FIG. 1 or 2, which is at 12 o'clock on circular drive sprocket 112) where chain 123 becomes disengaged with teeth 126. ECM 102, for example, could evaluate the motion data received from sensing segment 132 to identify a pattern of motion consistent with sensing segment 132 moving across the top of drive sprocket 112. ECM 102 could then identify when, based on the speed of track 110, sensing segment 132 reaches the location of interest. As discussed above, this location of interest may be a position in which track 110 would experience maximum sag between drive sprocket 112 and first idler 114 with machine 100 moving forward.

Step 506 of the method of FIG. 5 involves comparing motion data at the location of interest with target data for the location. Thus, after a controller such as ECM 102 determines that sensing segment 132 has reached at least the location of interest, perhaps the region of maximum sag for track 110, ECM 102 may compare the motion data received from motion sensor 204 with stored data indicating acceptable motion at that location for chain 123. As will be apparent to those of ordinary skill in the field, data indicating acceptable motion at that location may be collected from prior trial runs or simulations of machine 100 and could vary based on the characteristics of machine 100 and its intended use and environment.

After comparing motion data with stored data, in step 508, the processing equipment determines that the motion data at the location of interest is not compliant with target data for that location. ECM 102, or a controller within tension detector 202, could conclude that received motion data indicates a degree or type of motion for sensing segment 132 that is not compliant with stored target data by being either too high or too low. For example, the angular rate of motion at the location of interest for motion sensor 204 may be substantially higher, i.e., outside of a range of tolerance at a high end, than the acceptable angular rate of motion at that location, indicating that chain 123 has too much slack. Conversely, the received angular rate of motion at the location of interest may be substantially lower, i.e., outside the range of tolerance on a low end, than the expected or acceptable angular rate of motion at that location, indicating that chain 123 is too tight. It will be understood that ranges of tolerance, “substantially higher,” and “substantially lower” may vary based on the implementation for machine 100 and are within routine experimentation by one of ordinary skill in the field.

In a final step 510, the processing equipment generates an alert for operator of noncompliant tension for the track. If ECM 102 or similar processing equipment concludes in step 508 that the motion data is not compliant with stored target data, ECM 102 causes an alert to issue at least for the operator of machine 100. The alert may be delivered by an actuator (not shown) as a visual display on a dashboard of cabin 106, an audible alert within cabin 104, a signal provided to offboard to computing system 402, or other indication. Following the alert, the operator may either increase or decrease the tension of track 110 using track tension actuator 130 as required.

Those of ordinary skill in the field will appreciate that the principles of this disclosure are not limited to the specific examples discussed or illustrated in the figures. For example, while a tension detector has been illustrated and discussed for track 100 on one side of machine 100, a separate tension detector may be used for additional tracks, including one or more tracks on an opposite side of machine 100. Also, it will be appreciated that more than one tension detector may be used within track 110. While a monitor for monitoring track tension in an undercarriage of a work machine has been discussed in the context of slack between a drive sprocket and a front idler during forward movement, slack could also be evaluated in other spans, such as between a drive sprocket and a rear idler during reverse movement. Moreover, while the present disclosure addresses an undercarriage having a drive sprocket, a front idler, a rear idler, and track rollers, implementations having more or fewer track-guiding wheels are contemplated. In addition, the principles disclosed are not limited to implementation on a work machine having a chain-type track. Any vehicle using an endless track or belt for propulsion, or any device otherwise using a belt or chain drive that may experience a change in tension, could benefit from the examples and techniques disclosed and claimed.

### Industrial Applicability

The present disclosure provides systems and methods for monitoring tension in an undercarriage track on a work machine providing opportunities to adjust track tension and avoid undue wear. A work machine, such as a tractor or skid steer, has a motion sensor attached to a segment of a continuous ground-engaging track in its undercarriage. The motion sensor generates motion data indicative of a change in motion for the track segment as the track rotates around a track assembly. An electronic controller for the work machine receives and evaluates the motion data, first to identify a location of the track segment within the undercarriage and then to compare the motion data with expected motion data for the track segment under normal track tension. Motion data outside a range of the expected motion data indicates an abnormal sag in the track, causing the electronic controller to generate an alert for adjustment of the track tension. As a result, incorrect track tension can be automatically and accurately detected, leading to correction and avoidance of track slippage or undercarriage wear.

As noted above with respect to FIGS. 1-5, an example system for monitoring tension in an endless track of a machine 100 generally includes a drive sprocket 112, an idler 114, and an endless track 110 engaged with the drive sprocket and the idler for movement at least over a span between the drive sprocket and the idler. A motion sensor 204 is attached to a segment 132 of the endless track and configured to generate track data indicative of a change in motion by the motion sensor over the span. A memory is configured to store target data representative of an expected change in motion by the motion sensor 204 over the span, while a controller 102 is configured to determine that the track data is not within a range of the target data. When the track data is not within the range of the target data, an actuator generates an alert to adjust the track tension.

In the examples of the present disclosure, the motion sensor 204, which may be a gyroscope, an accelerometer, a vibration sensor, or a similar device for sensing a change in motion, provides a precise indicator of the path of travel for a chain 123 within a track 110. When provided with motion data from motion sensor 204, an electronic controller 102 can first identify a location of the motion sensor 204 based on historical data previously captured and stored in a memory. Then, the motion sensor passes through a span where track 110 typically sags, the electronic controller can compare the motion data with expected motion data for that span. When a deviation occurs, an alert can indicate to the operator that the tension of track 110 needs to be adjusted, either tighter or looser. The automatic detection provides increased accuracy of detection of tension deviations compared with a visual inspection or an assessment of hydraulic pressure. The automatic detection also enables a safety check of tension at periodic times, such as at the start of each working day, without disrupting operator routines and possibly simplifying them. Accordingly, tension of track 110 can be maintained at appropriate levels for machine 100, guarding against dangerous detachments of chain 123 and premature wear on the components of track assembly 108.

Unless explicitly excluded, the use of the singular to describe a component, structure, or operation does not exclude the use of plural such components, structures, or operations or their equivalents. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Terms of approximation are meant to include ranges of values that do not change the function or result of the disclosed structure or process. For instance, the term “about” generally refers to a range of numeric values that one of skill in the art would consider equivalent to the recited numeric value or having the same function or result. Similarly, the antecedent “substantially” means largely, but not wholly, the same form, manner or degree, and the particular element will have a range of configurations as a person of ordinary skill in the art would consider as having the same function or result. As an example, “substantially parallel” need not be exactly 180 degrees but may also encompass slight variations of a few degrees based on the context.

While aspects of the present disclosure have been particularly shown and described with reference to the embodiments above, it will be understood by those skilled in the art that various additional embodiments may be contemplated by the modification of the disclosed systems and methods without departing from the spirit and scope of what is disclosed. Such embodiments should be understood to fall within the scope of the present disclosure as determined based upon the claims and any equivalents thereof.

What is claimed is:

1. A system for monitoring tension in an endless track of a machine, comprising:
a drive sprocket having teeth around a circular periphery;
an idler having an outer circumference;
an endless track engaged with the teeth and with the outer circumference for movement at least over a span between the drive sprocket and the idler;
a motion sensor, attached to a segment of the endless track, configured to generate track data indicative of a change in motion by the motion sensor over the span;
a memory configured to store target data representative of an expected change in motion by the motion sensor over the span;
a controller configured to determine that the track data is not within a range of the target data; and
an actuator configured to generate an alert in response to the track data not being within the range of the target data.

2. The system of claim 1, wherein the endless track comprises a continuous chain formed from track links joined together by track pins, the motion sensor being attached to one of the track links.

3. The system of claim 2, wherein the motion sensor is embedded within a cavity in one of the track links.

4. The system of claim 1, wherein the endless track comprises track shoes attached to track links, the track links being joined together by track pins, the motion sensor being embedded within a cavity in one of the track shoes or in one of the track pins.

5. The system of claim 1, wherein the motion sensor is a gyroscope and the track data comprises an angular rate of motion for the motion sensor.

6. The system of claim 1, wherein the motion sensor is an accelerometer and the motion comprises a change in velocity for the motion sensor.

7. The system of claim 1, wherein the controller is an electronic control module within the machine communicatively coupled to the motion sensor.

8. The system of claim 1, wherein the controller is further configured to determine, based at least in part on the track data, a location of the segment of the endless track within the span during the movement.

9. A work machine, comprising:
an engine configured to provide propulsion for the work machine;
an undercarriage coupled to the engine for engaging a ground surface to move the work machine, comprising:
a drive sprocket,
an idler,
a ground-engaging track engaged with the drive sprocket and the idler for movement at least over a span between the drive sprocket and the idler, and
a motion sensor, attached to a segment of the ground-engaging track, configured to generate tension data indicative of a change in motion by the motion sensor over the span;
a memory configured to store target data representative of an expected change in motion by the motion sensor over the span; and
an electronic controller, communicatively coupled to the motion sensor, configured to receive the tension data and indicate an alert when the tension data is not within a range of the target data.

10. The work machine of claim 9, wherein the electronic controller is further configured to:
determine, based at least in part on the tension data, when the segment of the ground-engaging track is within the span.

11. The work machine of claim 9, wherein the range of the target data correlates to an acceptable amount of sag for the ground-engaging track within the span.

12. The work machine of claim 9, wherein the motion sensor is a MEMS gyroscope and the tension data indicates an angular rate of motion for the segment.

13. The work machine of claim 9, wherein the ground-engaging track comprises track links, track pins, and track shoes, the motion sensor being embedded within a cavity in one of the track links, track pins, or the track shoes.

14. The work machine of claim 13, wherein the motion sensor is combined in a circuit board with a battery and a wireless communication device, the wireless communication device being configured to communicate the tension data to the electronic controller.

15. A computer-implemented method of monitoring tension in a track within an undercarriage of a work machine, comprising:
receiving, by a processor, motion data from a motion sensor within a track segment during rotation of the track about a track assembly in the undercarriage;
comparing, by the processor, a portion of the motion data indicative of when the track segment was at a predetermined location offset from a drive sprocket with target motion data for the predetermined location stored in a memory;
determining that the portion of the motion data is not compliant with the target motion data; and
generating an alert relating to tension for the track.

16. The computer-implemented method of claim 15, further comprising:
determining, by the processor and based at least in part on the motion data, when the track segment is at the predetermined location.

17. The computer-implemented method of claim 16, wherein the determining when the motion sensor is at the predetermined location comprises:
identifying, by the processor, when the track segment passes over the drive sprocket based on changes in motion indicated by the motion data.

18. The computer-implemented method of claim 15, further comprising:
receiving, by the processor, initial motion data from the motion sensor during a previous rotation of the track about the track assembly; and
storing at least some of the initial motion data as the target motion data in the memory.

19. The computer-implemented method of claim 15, further comprising:
communicating the alert to an actuator for announcement for an operator of the work machine, the alert indicating that the tension of the track needs an adjustment.

20. The computer-implemented method of claim 19, wherein the alert indicates that the adjustment is to decrease the tension.
